(19) United States
(12) Patent Application Publication
(10) Pub. No.: US 2026/0089644 A1
(43) Pub. Date: Mar. 26, 2026

(54) POWER CONTROL FOR SDM BASED SIMULTANEOUS MULTI-PANEL PUSCH TRANSMISSION

(71) Applicant: LENOVO (BEIJING) LIMITED, Beijing (CN)

(72) Inventor: Bingchao LIU, Beijing (CN)

(21) Appl. No.: 19/108,577

(22) PCT Filed: Sep. 20, 2022
(86) PCT No.: PCT/CN2022/119885

§ 371 Date: Mar. 4, 2025

(51) Int. Cl. H04W 52/14; H04L 5/00; H04W 72/21; H04W 72/232

(52) U.S. Cl. CPC H04W 52/146; H04L 5/0053; H04W 72/21; H04W 72/232

(57) ABSTRACT

Methods and apparatuses for power control for SDM based simultaneous multi-panel PUSCH transmission are disclosed. In one embodiment, a UE comprises a transceiver; and a processor coupled to the transceiver, wherein the processor is configured to receive, via the transceiver, a DCI scheduling a SDM PUSCH transmission including a first set of PUSCH layer(s) associated with a first indicated UL TCI state and a second set of PUSCH layer(s) associated with a second indicated UL TCI state in a BWP (b) of a carrier (f) of a serving cell (c); and calculate transmit power for each of the first set of PUSCH layers associated with the first indicated UL TCI state and the second set of PUSCH layers associated with the second indicated UL TCI state according to transmission parameters corresponding to each of the first set of PUSCH layer(s) and the second set of PUSCH layer(s), respectively.

### FIELD

The subject matter disclosed herein generally relates to wireless communications, and more particularly relates to methods and apparatuses for power control for SDM based simultaneous multi-panel PUSCH transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC). User Entity/Equipment (Mobile Terminal), Transmitter (TX), Receiver (RX), frequency range 2 (FR2: 24.25 GHz to 52.6 GHz), reference signal (RS), Physical Uplink Shared Channel (PUSCH), Pathloss reference signal (PL-RS), Downlink Control Information (DCI), transmission reception point (TRP), Sounding Reference Signal (SRS), SRS resource indicator (SRI), Transmission Configuration Indicator (TCI), band width part (BWP), time division multiplexing (TDM), space division multiplexing (SDM), single frequency network (SFN), Simultaneous multi-panel UL transmission (STxMP), subcarrier spacing (SCS), resource block (RB), uplink shared channel (UL-SCH), codeword (CW), channel state information (CSI), Transmit Power Control Command (TPC).

Beam-specific power control procedure was specified in NR Release 15 for UL channels for beam-based UL transmission. For PUSCH transmission in FR2, a Tx beam as well as a set of power control parameters including the expected receiving power (P0), partial power compensation factor (alpha), pathloss reference signaling (PL-RS) and closed loop power control index/are indicated by a single SRI field in the DCI scheduling the PUSCH transmission for the UE to determine the Tx power of the scheduled PUSCH transmission.

Multi-TRP based PUSCH transmission with repetition was specified in NR Release 17, where multiple PUSCH transmissions with time domain repetition targeting different (e.g., two) TRPs can be scheduled by a single DCI. To support TRP-specific power control, two Tx beams as well as two sets of power control parameters are indicated by two SRI fields of the scheduling DCI, where each SRI field codepoint, i.e., the SRI field value, is associated with a spatial relation for determining the Tx beam and a set of power control parameters for determining the Tx power for PUSCH transmission targeting a different TRP.

Unified TCI framework for single-TRP scenario was specified in NR Release 17, where a common UL (or joint) TCI state is indicated for a BWP of a cell for a UE to determine the Tx beam for all PUSCH transmissions, and a PL-RS and a power control parameter setting, which is configured by RRC parameter p0-Alpha-CLID-PUSCHSet, including P0, alpha and closed loop index for PUSCH are associated with the common UL (or joint) TCI state for the UE to determine the Tx power for all the PUSCH transmissions.

Multi-panel (or multi-TRP) UL transmission with unified TCI framework shall be supported in NR Release 18. For TDM based PUSCH repetition scheme, different PUSCH transmissions targeting different TRPs shall be transmitted by different time slots, and two common UL (or joint) TCI states can be indicated for a BWP of a cell for a UE, where each UL (or joint) TCI state is associated with a set of power control parameters. SDM based simultaneous multi-panel PUSCH transmission (STxMP PUSCH) will be supported in NR Release 18. For SDM based STxMP PUSCH, different PUSCH layers of a same PUSCH transmission shall be transmitted by different (e.g., two) panels with different (e.g., two) beams. A same set of time-frequency resources, i.e., RBs, are indicated for PUSCH layers transmitted by different panels.

This invention targets the power control related issues for STxMP PUSCH transmission to support independent power control for different panels, e.g., the determination of Tx powers for different PUSCH layers transmitted by different panels.

### BRIEF SUMMARY

Methods and apparatuses for power control for SDM based simultaneous multi-panel PUSCH transmission are disclosed.

In one embodiment, a UE comprises a transceiver; and a processor coupled to the transceiver, wherein the processor is configured to receive, via the transceiver, a DCI scheduling a SDM PUSCH transmission including a first set of PUSCH layer(s) associated with a first indicated UL TCI state and a second set of PUSCH layer(s) associated with a second indicated UL TCI state in a BWP (b) of a carrier (f) of a serving cell (c); and calculate transmit power for each of the first set of PUSCH layers associated with the first indicated UL TCI state and the second set of PUSCH layers associated with the second indicated UL TCI state according to transmission parameters corresponding to each of the first set of PUSCH layer(s) and the second set of PUSCH layer(s), respectively.

In some embodiment, in determining transmission parameter Δ_{TF,b,f,c,t}(i) for each of the first indicated UL TCI state and the second indicated UL TCI state, for the SDM PUSCH transmission with UL-SCH data,

$${BPRE}_{t} = {\sum }_{r = 0}^{{C}_{t} - 1} {K}_{r} / {N}_{RE , t}$$

is calculated as follows: if only one codeword is scheduled, Cₜ is a number of transmitted code blocks of the one codeword, Kᵣ is a size for code block r, and N_{RE,t} is a number of resource elements for the scheduled SDM PUSCH transmission corresponding to the t^{th} indicated UL TCI state, and when N_{RE,t} is calculated, REs corresponding to all phase-tracking RS samples and all DMRS ports for the PUSCH layers associated with both the first indicated UL TCI state and the second indicated UL TCI state are excluded, or only REs corresponding to the phase-tracking RS samples and the DMRS port(s) for the PUSCH layer(s) associated with the t^{th} indicated UL TCI state are excluded; and if two codewords are scheduled, Cₜ is a number of transmitted code blocks for the codeword corresponding to the t^{th} indicated UL TCI state, Kᵣ is a size for code block r, and N_{RE,t} is a number of resource elements for the scheduled SDM PUSCH transmission corresponding to the t^{th} indicated UL TCI state, and when N_{RE,t} is calculated, only the PT-RS samples and the DMRS ports for the PUSCH layer(s) associated with the t^{th} indicated UL TCI state are excluded.

In some embodiment, when different closed loop indices are associated with the first indicated UL TCI state and the second indicated UL TCI state for the scheduled SDM PUSCH transmission, only the TPC command corresponding to the closed loop index associated with the first indicated UL TCI state, or the TPC command corresponding to the closed loop index associated with the second indicated UL TCI state, or the TPC command corresponding to the closed loop index=0) is applied to both the first set of PUSCH layer(s) and the second set of PUSCH layer(s).

In some other embodiment, when different closed loop indices are associated with the first indicated UL TCI state and the second indicated UL TCI state for the scheduled SDM PUSCH transmission, the TPC command corresponding to the closed loop index associated with the first indicated UL TCI state is applied to the first set of PUSCH layer(s), and the TPC command corresponding to the closed loop index associated with the second indicated UL TCI state is applied to the second set of PUSCH layer(s).

In some embodiment, the processor is further configured to report a capability on whether power sharing between different panels for simultaneous UL transmission is supported.

In some embodiment, when power sharing among different panels for simultaneous UL transmission is supported, and additional maximum output power P_{CMAX,f,c} across both panels is configured, if P_{PUSCH,b,f,c,1}(i, j, q_{d}, l)+P_{PUSCH,b,f,c,2}(i, j, q_{d}, l)>P_{CMAX,f,c}(i), the processor is further configured to perform power allocation for each of the first indicated UL TCI state and the second indicated UL TCI state by P′_{PUSCH,b,f,c,1}(i, j, q_{d}, l)=α×P_{CMAX,f,c}(i) and P′_{PUSCH,b,f,c,2}(i, j, q_{d}, l)=(1−α)×P_{CMAX,f,c}(i), where P_{PUSCH,b,f,c,1}(i, j, q_{d}, l) is the calculated transmit power for the first indicated UL TCI state, P_{PUSCH,b,f,c,2}(i, j, q_{d}, l) is the calculated transmit power for the second indicated UL TCI state, and α is a power allocation factor. The power allocation factor α is determined by one of

$$Option 1 : α = \frac{{P}_{PUSCH , b , f , c , 1} ( i , j , {q}_{d} , l )}{{P}_{PUSCH , b , f , c , 1} ( i , j , {q}_{d} , l ) + {P}_{PUSCH , b , f , c , 2} ( i , j , {q}_{d} , l )} ;$$

$$Option 2 : α = \frac{{P}_{CMAX , f , c , 1}}{{P}_{CMAX , f , c , 1} + {P}_{CMAX , f , c , 2}} ,$$

where P_{CMAX,f,c,1} is a configured maximum output power value associated with the first indicated UL TCI state, and P_{CMAX,f,c,2} is a configured maximum output power value associated with the second indicated UL TCI state:

$$Option 3 : α = \frac{\begin{matrix}number of PUSCH layers associated with \\ the first indicated UL TCI state\end{matrix}}{\begin{matrix}Total number of PUSCH layers associated with both \\ the first and the second indicated UL TCI states\end{matrix}} ;$$

Option 4: α is configured by RRC signaling; and

$$Option 5 : α = \frac{MCS 1}{MCS 1 + MCS 2} ,$$

where MCS1 is a modulation and coding scheme index corresponding to a first scheduled codeword, and MCS2 is a modulation and coding scheme index corresponding to a second scheduled codeword.

In particular, the transmit power for the first indicated UL TCI state is determined by \tilde{P}_{PUSCH,b,f,c,1}(i, j, q_{d}, l)=min{P_{CMAX,f,c,1}(i), P′_{PUSCH,b,f,c,1}(i, j, q_{d}, l)}, and the transmit power for the second indicated UL TCI state is determined by \tilde{P}_{PUSCH,b,f,c,2}(i, j, q_{d}, l)=min{P_{CMAX,f,c,2}(i), P′_{PUSCH,b,f,c,2}(i, j, q_{d}, l)}.

In some embodiment, the transmit power for each of the first indicated UL TCI state and the second indicated UL TCI state is applied by a scaling factor determined by the ratio of a number of antenna ports with non-zero PUSCH transmission power corresponding to said indicated UL TCI state over the maximum number of SRS ports supported by said indicated UL TCI state.

In another embodiment, a method performed at a UE comprises receiving a DCI scheduling a SDM PUSCH transmission including a first set of PUSCH layer(s) associated with a first indicated UL TCI state and a second set of PUSCH layer(s) associated with a second indicated UL TCI state in a BWP (b) of a carrier (f) of a serving cell (c); and 104 calculating transmit power for each of the first set of PUSCH layers associated with the first indicated UL TCI state and the second set of PUSCH layers associated with the second indicated UL TCI state according to transmission parameters corresponding to each of the first set of PUSCH layer(s) and the second set of PUSCH layer(s), respectively.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method; and

FIG. 2 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each FIGURE may refer to elements of proceeding figures. Like numbers refer to like elements in all figures, including alternate embodiments of like elements.

“Multi-TRP” means that a serving cell can have multiple (e.g., two) TRPs for DL transmission and/or UL reception. “Multi-panel” means that a UE can have multiple (e.g., two) panels for UL transmission and/or DL reception. In the condition that a UE with two panels (e.g., panel #1 and panel #2) transmit UL signal (e.g., PUSCH transmissions) on a serving cell to two TRPs (e.g., TRP #1 and TRP #2), the UE may use one panel (e.g., panel #1) to transmit UL signal to one TRP (e.g., TRP #1) of the serving cell and use the other panel (e.g., panel #2) to transmit UL signal to another TRP (e.g., TRP #2) of the serving cell. So, one panel is associated with one TRP. For example, panel #1 is associated with TRP #1, and panel #2 is associated with TRP #2. So, multi-panel multi-TRP scenario can be described as multi-panel/TRP.

Incidentally, in the following description, ‘PUSCH transmission’ may be abbreviated as ‘PUSCH’.

“Multi-panel/TRP simultaneous UL transmission” means the UE transmit UL signals from multiple panels (e.g., two panels) to multiple TRPs (e.g., two TRPs) simultaneously.

Two UL or joint TCI states are activated or indicated for UL signal transmitted from two panels to two TRPs for one BWP of a cell if unified TCI framework is configured.

UL TCI state is indicated when separate DL/UL TCI framework is configured, where the Tx beam for UL transmit and the Rx beam for DL reception are separately indicated by UL TCI state and DL TCI state, respectively. Each UL TCI state indicates a DL RS or an SRS for the UE to determine the TX spatial filter for UL transmission. In addition, a PL-RS is associated with the UL TCI state for the UE to calculate the DL channel path loss, and a set of power control parameters including P0, alpha and closed loop index for PUSCH is associated with each UL TCI state.

Joint TCI state is indicated when joint DL/UL TCI framework is configured, where both Tx beam for UL transmission and Rx beam for DL reception are determined by the indicated joint TCI state. Each joint TCI state indicates a DL RS for the UE to determine the TX spatial filter for UL transmission, and the RX spatial filter for DL reception. In addition, a PL-RS is associated with the joint TCI state for the UE to calculate the DL channel path loss, and a set of power control parameters including P0, alpha and closed loop index for PUSCH is associated with each joint TCI state.

As a whole, each activated or indicated UL or joint TCI state (which is abbreviated as “indicated UL TCI state” hereinafter) corresponds to a panel for UL transmission.

For SDM based STxMP PUSCH, different (e.g., two or more) PUSCH layers of a same PUSCH shall be transmitted by different (e.g., two) panels. In particular, the PUSCH layers of the same PUSCH is divided into a first set of PUSCH layer(s) and a second set of PUSCH laver(s), while the first set of PUSCH layer(s) is transmitted by a first panel (i.e., panel #1), and the second set of PUSCH layer(s) is transmitted by a second panel (i.e., panel #2). In the following description, ‘PUSCH layer’ may be abbreviated as ‘layer’.

The UE shall firstly determine the indicated UL TCI state for the layer(s) transmitted by each panel (i.e., each of the first panel and the second panel) by certain signaling, which can be a DCI, a MAC CE or a RRC signaling. The detailed implementation of the signaling for determining the indicated UL TCI state for the layer(s) transmitted by each panel is out of scope of this disclosure. Hereinafter, it is assumed that there are two indicated UL TCI states, i.e., a first indicated UL TCI state (which may be abbreviated as ‘TCI state #1’) and a second indicated UL TCI state (which may be abbreviated as ‘TCI state #2’), and that the first set of layer(s) to be transmitted by the first panel (i.e., panel #1) is associated with the first indicated UL TCI state and the second set of layer(s) to be transmitted by the second panel (i.e., panel #2) is associated with the second indicated UL TCI state.

A first embodiment relates to calculation of transmit power for each panel.

The UE receives a DCI scheduling a SDM PUSCH transmission with transmission occasion (i) in a BWP (b) of a carrier (f) of a serving cell (c), where the scheduled SDM PUSCH transmission includes a first set of layer(s) associated with a first indicated UL TCI state (corresponding to a first panel) and a second set of layer(s) associated with a second indicated UL TCI state (corresponding to a second panel).

According to the first embodiment, the UE calculates the transmit power for the PUSCH layers associated with the t^{th} (t=1 or 2) indicated UL TCI state, i.e., the t^{th} panel, based on Equation #1:

$${P}_{PUSCH , b , f , c , t} ( i , j , {q}_{d} , l ) = min \{ \begin{matrix}{P}_{CMAX , f , c , t} ( i ) \\ \begin{matrix}{P}_{{O}_{PUSCH} , b , f , c , t} ( j ) + 10 {log}_{10} ( {2}^{μ} \cdot {M}_{RB , b , f , c , t}^{PUSCH} ( i ) ) + \\ {α}_{b , f , c , t} ( j ) \cdot {PL}_{b , f , c} ( {q}_{d , t} ) + {Δ}_{TF , b , f , c , t} ( i ) + {f}_{b , f , c} ( i , l )\end{matrix}\end{matrix} \}$$

where,
i represents PUSCH transmission occasion, where each PUSCH transmission occasion corresponds to an occasion for a complete PUSCH transmission: j represents different PUSCH transmission types specified in Clause 7.1.1 of 3GPP Technical Specification TS38.213; and q_{d} represents an RS index for obtaining the downlink pathloss estimate for the PUSCH transmission.
(1) P_{CMAX,f,c,t}(i) is the configured maximum output power for the t^{th} panel. If only one P_{CMAX,f,c} is configured for carrier f of cell c, it shall be applied to both panels, i.e., P_{CMAX,f,c,1}=P_{CMAX,f,c,2}=P_{CMAX,f,c}.
(2) P_{O}_{_{PUSCH}}_{,b,f,c,t}(j) is obtained by the parameter P0 in p0-Alpha-CLID-PUSCHSet associated with the t^{th} indicated UL TCI state.
(3)

$${M}_{RB , b , f , c , t}^{PUSCH}$$

is the bandwidth of the PUSCH layers resources assignment expressed in number of RBs for the PUSCH transmission occasion i associated with the t^{th} indicated UL TCI state on active BWP b of carrier for serving cell c and μ is a SCS configured for the BWP b.
(4) α_{b,f,c,t}(j) is obtained by the parameter alpha in p0-Alpha-CLID-PUSCHSet associated with the t^{th} indicated UL TCI state.
(5) PL_{b,f,c}(q_{d,t}) is a DL pathloss estimate in dB calculated by UE using RS with index q_{d,t} configured by the PL-RS for the i^{th} indicated UL TCI state.
(6) Δ_{TF,b,f,c,t}(i) is the power control element for the MCS part

$${Δ}_{TF , b , f , c , t} ( i ) = 10 {log}_{10} ( ( {2}^{{BPRE}_{t} \cdot {K}_{s}} - 1 ) \cdot {β}_{offset}^{PUSCH} )$$

for Kₛ=1.25 and Δ_{TF,b,f,c,t}(i)=0 for Kₛ=0, where Kₛ is provided by RRC parameter deltaMCS configured for each UL BWP b of each carrier f and serving cell c. Two Kₛ values may be configured for a UL BWP of a cell for a UE that supports STxMP, where each deltaMCS (i.e., each Kₛ value) corresponds to an indicated UL TCI state, i.e., a UE panel. If only one deltaMCS is configured for the BWP, it shall be applied to both indicated UL TCI states, i.e., both panels. If more than one PUSCH layer is scheduled for the t^{th} indicated UL TCI state, Δ_{TF,b,f,c,t}(i)=0.
(6-1)

$${BPRE}_{t} = {\sum }_{r = 0}^{{C}_{t} - 1} {K}_{r} / {N}_{RE , t}$$

for PUSCH with UL-SCH data and

$${BPRE}_{t} = {Q}_{m , t} \cdot {R}_{t} / {β}_{offset , t}^{PUSCH}$$

for CSI transmission in a PUSCH without UL-SCH data.

One or two codewords (CWs) may be scheduled for the PUSCH transmission. If only one CW is scheduled, Cₜ is a number of transmitted code blocks of the one CW, Kᵣ is a size for code block r, and N_{RE,t} is a number of resource elements for the scheduled PUSCH corresponding to the t^{th} indicated UL TCI state. However, considering that separate PT-RS ports, each of which is used for phase noise estimation, and separate DMRS ports, each of which is used for channel estimation for demodulation, are configured for the PUSCH layers for different panels, two options are provided to calculate N_{RE,t}.

Option 11: REs corresponding to all the phase-tracking RS samples and all the DMRS ports associated with both indicated UL TCI states for the scheduled PUSCH are excluded to determine N_{RE,t}.

Option 12: Only REs corresponding to the phase-tracking RS samples and the DMRS port(s) of the PUSCH layers associated with the t^{th} indicated UL TCI state are excluded to determine N_{RE,t}. As a result, different BPREₜ may be determined for different panels according to Option 12.

Q_{m,t} is the modulation order and Rr is the target code rate provided by the DCI format scheduling the PUSCH transmission that includes CSI and does not include UL-SCH data.

$${β}_{offset , t}^{PUSCH}$$

is configured by RRC signaling when the PUSCH includes CSI and does not include UL-SCH data.

If two CWs (e.g., CW #0 and CW #1) are scheduled, each CW is associated with an indicated UL TCI state, e.g., CW #0 is associated with TCI state #1 and CW #1 is associated with TCI state #2. Each CW has a specific Cₜ and may have different MCS. Cₜ is a number of transmitted code blocks for the CW corresponding to the t^{th} indicated UL TCI state, Kᵣ is a size for code block r, and N_{RE,t} is a number of resource elements for the scheduled PUSCH corresponding to the t^{th} indicated UL TCI state. When N_{RE,t} is calculated, only the PT-RS samples and the DMRS ports of the PUSCH layers associated with the t^{th} indicated UL TCI state are excluded.

Q_{m,t} is the modulation order and Rₜ is the target code rate corresponding to the t^{th} indicated UL TCI state provided by the DCI format scheduling the PUSCH transmission that includes CSI and does not include UL-SCH data.

$${β}_{offset , t}^{PUSCH} = {β}_{offset , t}^{CSI , 1}$$

when the PUSCH includes CSI and does not include UL-SCH data.

As a whole, the power control element for the MCS part, i.e., Δ_{TF,b,f,c,t}(i), is determined by transmission parameters, e.g., the number of REs and the MCS parameters, for the corresponding PUSCH layer transmission.
(7)

$${f}_{b , f , c} ( i , l ) = {f}_{b , f , c} ( i - {i}_{0} , l ) + {\sum }_{m = 0}^{𝒞 ( {D}_{i} )} {δ}_{PUSCH , b , f , c} ( m , l )$$

is the PUSCH power control adjustment state l, i.e., the closed loop index, for active UL BWP b of carrier f of serving cell c and PUSCH transmission occasion i. Power control adjustment state l∈{0,1} is just the closed loop index which is indicated by p0-Alpha-CLID-PUSCHSet associated with each indicated UL TCI state. If the UE supports twoPUSCH-PC-AdjustmentStates and supports multi-panel UL transmission, two TPC fields can be configured to be contained in the scheduling DCI with format 0_1 or 0_2, where each TPC field indicates the TPC commands corresponding to each closed loop index. When a different PUSCH power control adjustment state l is indicated by each of the two indicated UL TCI states and two TPC fields are contained in the scheduling DCI, the TPC command applied to the PUSCH can be determined by two alternative methods:

Method 1: the scheduled PUSCH transmission shall be associated with only one closed loop index, in consideration that only one PUSCH transmission is scheduled although different PUSCH layers are transmitted by different panels. For example, the scheduled PUSCH transmission is associated with the closed loop index l indicated by the first indicated UL TCI state, or the closed loop index l indicated by the second indicated UL TCI state, or closed loop index l=0. A same TPC command indicated by one or the two TPC fields corresponding to the determined closed loop index l shall be applied to the PUSCH layers of the same PUSCH. Method 1 adopts the same principle as NR Release 15.

Method 2: the scheduled PUSCH transmission shall be associated with one or two closed loop indices according to the closed loop index or indices indicated by two indicated UL TCI states. It means that each indicated UL TCI state may indicate a different closed loop index or both indicated UL TCI states may indicate a same closed loop index. The UE shall determine the transmit power of the PUSCH layer(s) for each panel by applying the TPC command for the closed loop indicated by the indicated UL TCI state associated with the panel. Different TPC commands are applied to different PUSCH layers of the same PUSCH when different closed loop index l is indicated by a different indicated UL TCI state. That is, the TPC command corresponding to the closed loop index associated with the first indicated UL TCI state is applied to the first set of layer(s), and the TPC command corresponding to the closed loop index associated with the second indicated UL TCI state is applied to the second set of layer(s).

So, as transmission parameters, the PUSCH power control adjustment state l, i.e., the closed loop index, is determined in consideration of each of the first set of layer(s) and the second set of layer(s).

It can be seen from the first embodiment that a same PUSCH transmission occasion shall be transmitted by different beams with different transmit powers with different transmission parameters.

A second embodiment relates to allocation of transmit power between two panels.

The UE may report to the gNB a capability on whether power sharing between different panels for simultaneous UL transmission is supported. If power sharing between different panels for simultaneous UL transmission is supported and the UE is configured with a maximum output power P_{CMAX,f,c} across both panels, the final transmit power of each panel (i.e., P_{PUSCH,b,f,c,1}(i, j, q_{d}, l) for panel #1 and P_{PUSCH,b,f,c,2}(i, j, q_{d}, l) for panel #2) shall be determined by the following procedure:

$$If {P}_{PUSCH , b , f , c , 1} ( i , j , {q}_{d} , l ) + {P}_{PUSCH , b , f , c , 2} ( i , j , {q}_{d} , l ) \leq {P}_{CMAX , f , c} ( i ) ,$$

P_{PUSCH,b,f,c,t}(i, j, q_{d}, l) (where t=1 or 2) is determined as the transmit power for the l^{th} panel.

If P_{PUSCH,b,f,c,1}(i, j, q_{d}, l)+P_{PUSCH,b,f,c,2}(i, j, q_{d}, l)>P_{CMAX,f,c}(i), the UE first determines P′_{PUSCH,b,f,c,1}(i, j, q_{d}, l)=α×P_{CMAX,f,c}(i) to panel #1 and P′_{PUSCH,b,f,c,2}(i, j, q_{d}, l)=(1−α)×P_{CMAX,f,c}(i) to panel #2, where α is a power allocation factor that can be determined by one of the following options 21 to 25:

$$Option 21 : α = \frac{{P}_{PUSCH , b , f , c , 1} ( i , j , {q}_{d} , l )}{{P}_{PUSCH , b , f , c , 1} ( i , j , {q}_{d} , l ) + {P}_{PUSCH , b , f , c , 2} ( i , j , {q}_{d} , l )}$$

$$Option 22 : α = \frac{{P}_{CMAX , f , c , 1}}{{P}_{CMAX , f , c , 1} + {P}_{CMAX , f , c , 2}} ,$$

where P_{CMAX,f,c,1} and P_{CMAX,f,c,2} are two maximum output power values for the carrier f of the serving cell c, and P_{CMAX,f,c,1} corresponds to a configured maximum output power value associated with panel #1 (or associated with the first indicated UL TCI state), and P_{CMAX,f,c,2} corresponds to a configured maximum output power value associated with panel #2 (or associated with the second indicated UL TCI state).

$$Option 23 : α = \frac{\begin{matrix}number of PUSCH layers associated with the \\ first indicated UL TCI state\end{matrix}}{\begin{matrix}Total number of PUSCH layers associated with \\ both the first and the second indicated UL TCI states\end{matrix}} ,$$

Option 24: a is configured by RRC signaling.

$$Option 25 : α = \frac{MCS 1}{MCS 1 + MCS 2} ,$$

if only one CW is scheduled, MCS2=MCS1. MCS is the Modulation and Coding Scheme for a CW, and different Modulation and Coding Scheme has different MCS index. MCS1 and MCS2 are two modulation and coding scheme indices corresponding to the two scheduled CWs.

The actual transmit power for each panel is determine by:

$${\tilde{P}}_{PUSCH , b , f , c , t} ( i , j , {q}_{d} , l ) = min \{ {P}_{CMAX , f , c , t} ( t ) , {P}_{PUSCH , b , f , c , t}^{′} ( i , j , {q}_{d} , l ) \} ,$$

$$where t = 1 or 2.$$

$$In particular , {\tilde{P}}_{PUSCH , b , f , c , 1} ( i , j , {q}_{d} , l ) = min \{ {P}_{CMAX , f , c , 1} ( i ) , {P}_{PUSCH , b , f , c , 1}^{′} ( i , j , {q}_{d} , l ) \} for panel \#1 , and$$

$${\tilde{P}}_{PUSCH , b , f , c , 2} ( i , j , {q}_{d} , l ) = min \{ {P}_{CMAX , f , c , 2} ( i ) , {P}_{PUSCH , b , f , c , 2}^{′} ( i , j , {q}_{d} , l ) \} for panel \#2 .$$

A third embodiment relates to allocation of transmit power for each antenna port for each panel.

The actual transmit power for each panel \tilde{P}_{PUSCH,b,f,c,t}(i, j, q_{d}, l) is scaled by a power scale factor sₜ, where

$${s}_{t} = \frac{\begin{matrix}a number of antenna ports with non - zero PUSCH \\ transmission power of the {t}^{th} panel\end{matrix}}{the maximum number of SRS ports supported by the {t}^{th} panel}$$

For example, it is assumed that there are two panels: panel #1 and panel #2, each of which has 4 antenna ports. Panel #1 and panel #2 are used by a UE for SDM based STxMP PUSCH transmission.

Suppose that a precoding matrix

$$w = {\frac{1}{2} [ 1 , 0 , 1 , 0 ]}^{T}$$

is indicated for the PUSCH layer (e.g., one layer) for the first indicated UL TCI state for panel #1, and a precoding matrix

$$w = {\frac{1}{2} [ \begin{matrix}1 , 0 , 1 , 0 \\ 0 , 1 , 0 , j\end{matrix} ]}^{T}$$

is indicated for the PUSCH layers (e.g., two layers) for the second indicated UL TCI state of panel #2. Each column of w corresponds to one antenna port for PUSCH transmission and each row of the precoding matrix w corresponds to one PUSCH layer. So, the maximum number of SRS ports (i.e., antenna ports) supported by each of panel #1 and panel #2 is 4.

For panel #1, the number of antenna ports with non-zero PUSCH transmission power (i.e., the number of columns with non-zero values) is 2. So, sₜ for panel #1 (i.e., s₁) is 2/4=½. For panel #2, the number of antenna ports with non-zero PUSCH transmission power (i.e., the number of columns with non-zero values) is 4. So, sₜ for panel #2 (i.e., s₂) is 4/4=1.

After the UE scales \tilde{P}_{PUSCH,b,f,c,t}(i, j, q_{d}, l) by sₜ, the UE splits each panel's actual transmit power (i.e., sₜ×\tilde{P}_{PUSCH,b,f,c,t}(i, j, q_{d}, l) equally across the antenna ports of each panel on which the UE transmits the corresponding PUSCH layer(s) with non-zero power.

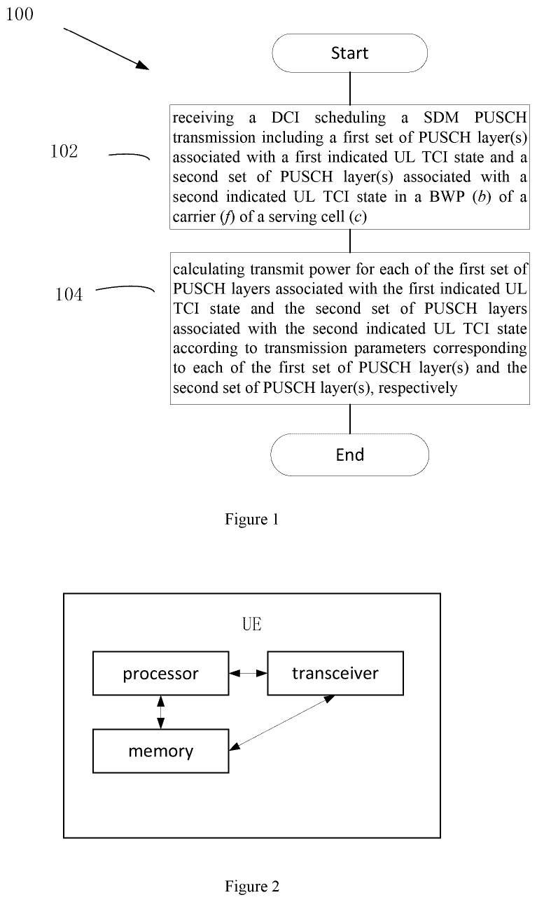

FIG. 1 is a schematic flow chart diagram illustrating an embodiment of a method 100 according to the present application. In some embodiments, the method 100 is performed by an apparatus, such as a remote unit (e.g., UE). In certain embodiments, the method 100 may be performed by a processor executing program code, for example, a microcontroller, a microprocessor, a CPU, a GPU, an auxiliary processing unit, a FPGA, or the like.

The method 100 is a method performed at a UE, comprising: 102 receiving a DCI scheduling a SDM PUSCH transmission including a first set of layer(s) associated with a first indicated UL TCI state and a second set of layer(s) associated with a second indicated UL TCI state in a BWP (b) of a carrier (f) of a serving cell (c); and 104 calculating transmit power for each of the first indicated UL TCI state and the second indicated UL TCI state according to transmission parameters corresponding to each of the first set of layer(s) and the second set of layer(s), respectively.

In some embodiment, in determining transmission parameter Δ_{TF,b,f,c,t}(i) for each of the first indicated UL TCI state and the second indicated UL TCI state, for the SDM PUSCH transmission with UL-SCH data,

$${BPRE}_{t} = {\sum }_{r = 0}^{{C}_{t} - 1} {K}_{r} / {N}_{RE , t}$$

is calculated as follows: if only one codeword is scheduled, Cₜ is a number of transmitted code blocks of the one codeword, Kᵣ is a size for code block r, and N_{RE,t} is a number of resource elements for the scheduled SDM PUSCH transmission corresponding to the t^{th} indicated UL TCI state, and when N_{RE,t} is calculated, REs corresponding to all phase-tracking RS samples and all DMRS ports for the layers associated with both the first indicated UL TCI state and the second indicated UL TCI state are excluded, or only REs corresponding to the phase-tracking RS samples and the DMRS port(s) for the layer(s) associated with the t^{th} indicated UL TCI state are excluded; and if two codewords are scheduled, Cₜ is a number of transmitted code blocks for the codeword corresponding to the t^{th} indicated UL TCI state, Kᵣ is a size for code block r, and N_{RE,t} is a number of resource elements for the scheduled SDM PUSCH transmission corresponding to the t^{th} indicated UL TCI state, and when N_{RE,t is calculated, only the PT-RS samples and the DMRS ports for the layer(s) associated with the t}^{th} indicated UL TCI state are excluded.

In some embodiment, when different closed loop indices are associated with the first indicated UL TCI state and the second indicated UL TCI state for the scheduled SDM PUSCH transmission, only the TPC command corresponding to the closed loop index associated with the first indicated UL TCI state, or the TPC command corresponding to the closed loop index associated with the second indicated UL TCI state, or the TPC command corresponding to the closed loop index=0 is applied to both the first set of layer(s) and the second set of layer(s).

In some other embodiment, when different closed loop indices are associated with the first indicated UL TCI state and the second indicated UL TCI state for the scheduled SDM PUSCH transmission, the TPC command corresponding to the closed loop index associated with the first indicated UL TCI state is applied to the first set of layer(s), and the TPC command corresponding to the closed loop index associated with the second indicated UL TCI state is applied to the second set of layer(s).

In some embodiment, the method further comprises reporting a capability on whether power sharing between different panels for simultaneous UL transmission is supported.

In some embodiment, when power sharing among different panels for simultaneous UL transmission is supported, and additional maximum output power P_{CMAX,f,c} across both panels is configured, if P_{PUSCH,b,f,c,1}(i, j, q_{d}, l)+P_{PUSCH,b,f,c,2}(i, j, q_{d}, l)>P_{CMAX,f,c}(i), the method further comprises performing power allocation for each of the first indicated UL TCI state and the second indicated UL TCI state by P′_{PUSCH,b,f,c,1}(i, j, q_{d}, l)=α×P_{CMAX,f,c}(i) and P′_{PUSCH,b,f,c,2}(i, j, q_{d}, l)=(1−α)×P_{CMAX,f,c}(i) where P_{PUSCH,b,f,c,1}(i, j, q_{d}, l) is the calculated transmit power for the first indicated UL TCI state, P_{PUSCH,b,f,c,2}(i, j, q_{d}, l) is the calculated transmit power for the second indicated UL TCI state, and α is a power allocation factor. The power allocation factor α is determined by one of

$$Option 1 : α = \frac{{P}_{PUSCH , b , f , c , 1} ( i , j , {q}_{d} , l )}{{P}_{PUSCH , b , f , c , 1} ( i , j , {q}_{d} , l ) + {P}_{PUSCH , b , f , c , 2} ( i , j , {q}_{d} , l )} ;$$

$$Option 2 : α = \frac{{P}_{CMAX , f , c , 1}}{{P}_{CMAX , f , c , 1} + {P}_{CMAX , f , c , 2}} ,$$

where P_{CMAX,f,c,1} is a configured maximum output power value associated with the first indicated UL TCI state, and P_{CMAX,f,c,2} is a configured maximum output power value associated with the second indicated UL TCI state;

$$Option 3 : α = \frac{\begin{matrix}number of PUSCH layers associated with \\ the first indicated UL TCI state\end{matrix}}{\begin{matrix}Total number of PUSCH layer associated with both the \\ first and the second indicated UL TCI states\end{matrix}} ,$$

Option 4: α is configured by RRC signaling; and

$$Option 5 : α = \frac{MCS 1}{MCS 1 + MCS 2} ,$$

where MCS1 is a modulation and coding scheme index corresponding to a first scheduled codeword, and MCS2 is a modulation and coding scheme index corresponding to a second scheduled codeword.

In particular, the transmit power for the first indicated UL TCI state is determined by \tilde{P}_{PUSCH,b,f,c,1}(i, j, q_{d}, l)=min{P_{CMAX,f,c,1}(i), P′_{PUSCH,b,f,c,1}(i, j, q_{d}, l)}, and the transmit power for the second indicated UL TCI state is determined by \tilde{P}_{PUSCH,b,f,c,2}(i, j, q_{d}, l)=min{P_{CMAX,f,c,2}(i), P′_{PUSCH,b,f,c,2}(i, j, q_{d}, l)}.

In some embodiment, the transmit power for each of the first indicated UL TCI state and the second indicated UL TCI state is applied by a scaling factor determined by the ratio of a number of antenna ports with non-zero PUSCH transmission power corresponding to said indicated UL TCI state over the maximum number of SRS ports supported by said indicated UL TCI state.

FIG. 2 is a schematic block diagram illustrating apparatuses according to one embodiment.

Referring to FIG. 2, the UE (i.e., the remote unit) includes a processor, a memory, and a transceiver. The processor implements a function, a process, and/or a method which are proposed in FIG. 1.

The UE comprises a transceiver; and a processor coupled to the transceiver, wherein the processor is configured to receive, via the transceiver, a DCI scheduling a SDM PUSCH transmission including a first set of layer(s) associated with a first indicated UL TCI state and a second set of layer(s) associated with a second indicated UL TCI state in a BWP (b) of a carrier (f) of a serving cell (c); and calculate transmit power for each of the first indicated UL TCI state and the second indicated UL TCI state according to transmission parameters corresponding to each of the first set of layer(s) and the second set of layer(s), respectively.

In some embodiment, in determining transmission parameter Δ_{TF,b,f,c,t}(i) for each of the first indicated UL TCI state and the second indicated UL TCI state, for the SDM PUSCH transmission with UL-SCH data,

$${BPRE}_{t} = {\sum }_{r = 0}^{{C}_{t} - 1} {K}_{r} / {N}_{RE , t}$$

is calculated as follows: if only one codeword is scheduled, Cₜ is a number of transmitted code blocks of the one codeword, Kᵣ is a size for code block r, and N_{RE,t} is a number of resource elements for the scheduled SDM PUSCH transmission corresponding to the t^{th} indicated UL TCI state, and when N_{RE,t} is calculated, REs corresponding to all phase-tracking RS samples and all DMRS ports for the layers associated with both the first indicated UL TCI state and the second indicated UL TCI state are excluded, or only REs corresponding to the phase-tracking RS samples and the DMRS port(s) for the layer(s) associated with the t^{th} indicated UL TCI state are excluded; and if two codewords are scheduled, Cₜ is a number of transmitted code blocks for the codeword corresponding to the t^{th} indicated UL TCI state, Kᵣ is a size for code block r, and N_{RE,t} is a number of resource elements for the scheduled SDM PUSCH transmission corresponding to the t^{th} indicated UL TCI state, and when N_{RE,t} is calculated, only the PT-RS samples and the DMRS ports for the layer(s) associated with the t^{th} indicated UL TCI state are excluded.

In some embodiment, when different closed loop indices are associated with the first indicated UL TCI state and the second indicated UL TCI state for the scheduled SDM PUSCH transmission, only the TPC command corresponding to the closed loop index associated with the first indicated UL TCI state, or the TPC command corresponding to the closed loop index associated with the second indicated UL TCI state, or the TPC command corresponding to the closed loop index=0 is applied to both the first set of layer(s) and the second set of layer(s).

In some other embodiment, when different closed loop indices are associated with the first indicated UL TCI state and the second indicated UL TCI state for the scheduled SDM PUSCH transmission, the TPC command corresponding to the closed loop index associated with the first indicated UL TCI state is applied to the first set of layer(s), and the TPC command corresponding to the closed loop index associated with the second indicated UL TCI state is applied to the second set of layer(s).

In some embodiment, the processor is further configured to report a capability on whether power sharing between different panels for simultaneous UL transmission is supported.

In some embodiment, when power sharing among different panels for simultaneous UL transmission is supported, and additional maximum output power P_{CMAX,f,c} across both panels is configured, if P_{PUSCH,b,f,c,1}(i, j, q_{d}, l)+P_{PUSCH,b,f,c,2}(i, j, q_{d}, l)>P_{CMAX,f,c}(i), the processor is further configured to perform power allocation for each of the first indicated UL TCI state and the second indicated UL TCI state by P′_{PUSCH,b,f,c,1}(i, j, q_{d}, l)=α×P_{CMAX,f,c}(i) and P′_{PUSCH,b,f,c,2}(i, j, q_{d}, l)=(1−α)×P_{CMAX,f,c}(i), where P_{PUSCH,b,f,c,1}(i, j, q_{d}, l) is the calculated transmit power for the first indicated UL TCI state, P_{PUSCH,b,f,c,2}(i, j, q_{d}, l) is the calculated transmit power for the second indicated UL TCI state, and α is a power allocation factor. The power allocation factor α is determined by one of

$$Option 1 : α = \frac{{P}_{PUSCH , b , f , c , 1} ( i , j , {q}_{d} , l )}{{P}_{PUSCH , b , f , c , 1} ( i , j , {q}_{d} , l ) + {P}_{PUSCH , b , f , c , 2} ( i , j , {q}_{d} , l )} ;$$

$$Option 2 : α = \frac{{P}_{CMAX , f , c , 1}}{{P}_{CMAX , f , c , 1} + {P}_{CMAX , f , c , 2}} ,$$

where P_{CMAX,f,c,1} is a configured maximum output power value associated with the first indicated UL TCI state, and P_{CMAX,f,c,2} is a configured maximum output power value associated with the second indicated UL TCI state;

$$Option 3 : α = \frac{\begin{matrix}number of PUSCH layers associated with \\ the first indicated UL TCI state\end{matrix}}{\begin{matrix}Total number of PUSCH layer associated with both the \\ first and the second indicated UL TCI states\end{matrix}} ;$$

Option 4: α is configured by RRC signaling; and

$$Option 5 : α = \frac{MCS 1}{MCS 1 + MCS 2} ,$$

where MCS1 is a modulation and coding scheme index corresponding to a first scheduled codeword, and MCS2 is a modulation and coding scheme index corresponding to a second scheduled codeword.

In particular, the transmit power for the first indicated UL TCI state is determined by \tilde{P}_{PUSCH,b,f,c,1}(i, j, q_{d}, l)=min{P_{CMAX,f,c,1}(i), P′_{PUSCH,b,f,c,1}(i, j, q_{d}, l)}, and the transmit power for the second indicated UL TCI state is determined by \tilde{P}_{PUSCH,b,f,c,2}(i, j, q_{d}, l)=min{P_{CMAX,f,c,2}(i), P′_{PUSCH,b,f,c,2}(i, j, q_{d}, l)}.

In some embodiment, the transmit power for each of the first indicated UL TCI state and the second indicated UL TCI state is applied by a scaling factor determined by the ratio of a number of antenna ports with non-zero PUSCH transmission power corresponding to said indicated UL TCI state over the maximum number of SRS ports supported by said indicated UL TCI state.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a downlink control information (DCI) scheduling a space division multiplexing (SDM) physical uplink shared channel (PUSCH) transmission including a first set of PUSCH layers associated with a first indicated uplink (UL) transmission configuration indicator (TCI) state and a second set of PUSCH layers associated with a second indicated UL TCI state in a bandwidth partition (BWP) (b) of a carrier (f) of a serving cell (c); and
calculate transmit power for each of the first set of PUSCH layers associated with the first indicated UL TCI state and the second set of PUSCH layers associated with the second indicated UL TCI state according to transmission parameters corresponding to each of the first set of PUSCH layers and the second set of PUSCH layers, respectively.

2. The UE of claim 1, wherein, in determining a transmission parameter Δ_{TF,b,f,c,t}(i) for each of the first indicated UL TCI state and the second indicated UL TCI state, for the SDM PUSCH transmission with UL-SCH data, the at least one processor is configured to cause the UE to calculate
$${BPRE}_{t} = {\sum }_{r = 0}^{{C}_{t} - 1} {K}_{r} / {N}_{RE , t}$$
as follows:
if only one codeword is scheduled, Cₜ is a number of transmitted code blocks of the one codeword, Kᵣ is a size for code block r, and N_{RE,t} is a number of resource elements for the scheduled SDM PUSCH transmission corresponding to an t^{th} indicated UL TCI state, and when N_{RE,t} is calculated, resource elements (REs) corresponding to all phase-tracking reference signal (RS) samples and all demodulation reference signal (DMRS) ports for the PUSCH layers associated with both the first indicated UL TCI state and the second indicated UL TCI state are excluded, or only REs corresponding to the phase-tracking RS samples and the DMRS ports for the PUSCH layers associated with the t^{th} indicated UL TCI state are excluded; and
if two codewords are scheduled, Cₜ is a number of transmitted code blocks for the codeword corresponding to the t^{th} indicated UL TCI state, Kᵣ is a size for code block r, and N_{RE,t} is a number of resource elements for the scheduled SDM PUSCH transmission corresponding to the t^{th} indicated UL TCI state, and when N_{RE,t} is calculated, only the phase tracking-RS (PT-RS) samples and the DMRS ports for the PUSCH layers associated with the t^{th} indicated UL TCI state are excluded.

3. The UE of claim 1, wherein, when different closed loop indices are associated with the first indicated UL TCI state and the second indicated UL TCI state for the scheduled SDM PUSCH transmission, only a transmit power control (TPC) command corresponding to a closed loop index associated with the first indicated UL TCI state, or a TPC command corresponding to a closed loop index associated with the second indicated UL TCI state, or a TPC command corresponding to a closed loop index=0 is applied to both the first set of PUSCH layers and the second set of PUSCH layers.

4. The UE of claim 1, wherein, when different closed loop indices are associated with the first indicated UL TCI state and the second indicated UL TCI state for the scheduled SDM PUSCH transmission, a TPC command corresponding to a closed loop index associated with the first indicated UL TCI state is applied to the first set of PUSCH layers, and a TPC command corresponding to a closed loop index associated with the second indicated UL TCI state is applied to the second set of PUSCH layers.

5. The UE of claim 1, wherein the at least one processor is further configured to cause the UE to report a capability on whether power sharing between different panels for simultaneous UL transmission is supported.

6. The UE of claim 1, wherein, when power sharing among different panels for simultaneous UL transmission is supported, and additional maximum output power P_{CMAX,f,c} across both panels is configured, if P_{PUSCH,b,f,c,1}(i, j, q_{d}, l)+P_{PUSCH,b,f,c,2}(i, j, q_{d}, l)>P_{CMAX,f,c}(i), the at least one processor is further configured to cause the UE to perform power allocation for each of the first indicated UL TCI state and the second indicated UL TCI state by P′_{PUSCH,b,f,c,1}(i, j, q_{d}, l)=α×P_{CMAX,f,c}(i) and P′_{PUSCH,b,f,c,2}(i, j, q_{d}, l)=(1−α)×P_{CMAX,f,c}(i), where P_{PUSCH,b,f,c,1}(i, j, q_{d}, l) is the calculated transmit power for the first indicated UL TCI state, P_{PUSCH,b,f,c,2}(i, j, q_{d}, l) is the calculated transmit power for the second indicated UL TCI state, and α is a power allocation factor.

7. The UE of claim 6, wherein the power allocation factor α is determined by:
$$Option 1 : α = \frac{{P}_{PUSCH , b , f , c , 1} ( i , j , {q}_{d} , l )}{{P}_{PUSCH , b , f , c , 1} ( i , j , {q}_{d} , l ) + {P}_{PUSCH , b , f , c , 2} ( i , j , {q}_{d} , l )} ;$$
$$Option 2 : α = \frac{{P}_{CMAX , f , c , 1}}{{P}_{CMAX , f , c , 1} + {P}_{CMAX , f , c , 2}} ,$$
where P_{CMAX,f,c,1} is a configured maximum output power value associated with the first indicated UL TCI state, and P_{CMAX,f,c,2} is a configured maximum output power value associated with the second indicated UL TCI state;
$$Option 3 : α = \frac{\begin{matrix}number of PUSCH layers associated with \\ the first indicated UL TCI state\end{matrix}}{\begin{matrix}Total number of PUSCH layer associated with both the \\ first and the second indicated UL TCI states\end{matrix}} ;$$
Option 4: α is configured by radio resource control (RRC) signaling; or
$$Option 5 : α = \frac{MCS 1}{MCS 1 + MCS 2} ,$$
where MCS1 is a modulation and coding scheme index corresponding to a first scheduled codeword, and MCS2 is a modulation and coding scheme index corresponding to a second scheduled codeword.

8. The UE of claim 6, wherein the at least one processor is configured to cause the UE to: determine the transmit power for the first indicated UL TCI state by \tilde{P}_{PUSCH,b,f,c,1}(i, j, q_{d}, l)=min{P_{CMAX,f,c,1}(i), P′_{PUSCH,b,f,c,1}(i, j, q_{d}, l)}, and determine the transmit power for the second indicated UL TCI state by
$${\tilde{P}}_{PUSCH , b , f , c , 2} ( i , j , {q}_{d} , l ) = min \{ {P}_{CMAX , f , c , 2} ( i ) , {P}_{PUSCH , b , f , c , 2}^{′} ( i , j , {q}_{d} , l ) \} .$$

9. The UE of claim 1, wherein the transmit power for each of the first indicated UL TCI state and the second indicated UL TCI state is applied by a scaling factor determined by the ratio of a number of antenna ports with non-zero PUSCH transmission power corresponding to the indicated UL TCI state over the maximum number of sounding reference signal (SRS) ports supported by the indicated UL TCI state.

10. A method performed by a user equipment (UE), the method comprising:
receiving a downlink control information (DCI) scheduling a space division multiplexing (SDM) physical uplink shared channel (PUSCH) transmission including a first set of PUSCH layers associated with a first indicated uplink (UL) transmission configuration indicator (TCI) state and a second set of PUSCH layers associated with a second indicated UL TCI state in a bandwidth partition (BWP) (b) of a carrier (f) of a serving cell (c); and
calculating transmit power for each of the first set of PUSCH layers associated with the first indicated UL TCI state and the second set of PUSCH layers associated with the second indicated UL TCI state according to transmission parameters corresponding to each of the first set of PUSCH layers and the second set of PUSCH layers, respectively.

11. The method of claim 10, wherein, in determining transmission parameter Δ_{TF,b,f,c,t}(i) for each of the first indicated UL TCI state and the second indicated UL TCI state, for the SDM PUSCH transmission with UL-SCH data,
$${BPRE}_{t} = {\sum }_{r = 0}^{{C}_{t} - 1} {K}_{r} / {N}_{RE , t}$$
is calculated as follows:
if only one codeword is scheduled, Cₜ is a number of transmitted code blocks of the one codeword, Kᵣ is a size for code block r, and N_{RE,t} is a number of resource elements for the scheduled SDM PUSCH transmission corresponding to the t^{th} indicated UL TCI state, and when N_{RE,t} is calculated, resource elements (REs) corresponding to all phase-tracking reference signal (RS) samples and all demodulation reference signal (DMRS) ports for the PUSCH layers associated with both the first indicated UL TCI state and the second indicated UL TCI state are excluded, or only REs corresponding to the phase-tracking RS samples and the DMRS ports for the PUSCH layers associated with the t^{th} indicated UL TCI state are excluded; and
if two codewords are scheduled, Cₜ is a number of transmitted code blocks for the codeword corresponding to the t^{th} indicated UL TCI state, Kᵣ is a size for code block r, and N_{RE,t} is a number of resource elements for the scheduled SDM PUSCH transmission corresponding to the t^{th} indicated UL TCI state, and when N_{RE,t} is calculated, only the PT-RS samples and the DMRS ports for the PUSCH layers associated with the t^{th} indicated UL TCI state are excluded.

12. The method of claim 10, wherein, when different closed loop indices are associated with the first indicated UL TCI state and the second indicated UL TCI state for the scheduled SDM PUSCH transmission, only a transmission power control (TPC) command corresponding to a closed loop index associated with the first indicated UL TCI state, or a TPC command corresponding to a closed loop index associated with the second indicated UL TCI state, or a TPC command corresponding to a closed loop index=0 is applied to both the first set of PUSCH layers and the second set of PUSCH layers.

13. The method of claim 10, wherein, when different closed loop indices are associated with the first indicated UL TCI state and the second indicated UL TCI state for the scheduled SDM PUSCH transmission, a transmission power control (TPC) command corresponding to a closed loop index associated with the first indicated UL TCI state is applied to the first set of PUSCH layers, and a TPC command corresponding to a closed loop index associated with the second indicated UL TCI state is applied to the second set of PUSCH layers.

14. The method of claim 10, further comprising: reporting a capability on whether power sharing between different panels for simultaneous UL transmission is supported.

15. The method of claim 10, wherein, when power sharing among different panels for simultaneous UL transmission is supported, and additional maximum output power P_{CMAX,f,c} across both panels is configured, if P_{PUSCH,b,f,c,1}(i, j, q_{d}, l)+P_{PUSCH,b,f,c,2}(i, j, q_{d}, l)>P_{CMAX,f,c}(i), the method further comprises; performing power allocation for each of the first indicated UL TCI state and the second indicated UL TCI state by P′_{PUSCH,b,f,c,1}(i, j, q_{d}, l)=α×P_{CMAX,f,c}(i) and P′_{PUSCH,b,f,c,2}(i, j, q_{d}, l)=(1−α)×P_{CMAX,f,c}(i), where P_{PUSCH,b,f,c,1}(i, j, q_{d}, l) is the calculated transmit power for the first indicated UL TCI state, P_{PUSCH,b,f,c,2}(i, j, q_{d}, l) is the calculated transmit power for the second indicated UL TCI state, and a is a power allocation factor.

16. A processor for wireless communication, comprising:
at least one controller coupled with the at least one memory and configured to cause the processor to:
receive a downlink control information (DCI) scheduling a space division multiplexing (SDM) physical uplink shared channel (PUSCH) transmission including a first set of PUSCH layers associated with a first indicated uplink (UL) transmission configuration indicator (TCI) state and a second set of PUSCH layers associated with a second indicated UL TCI state in a bandwidth partition (BWP) (b) of a carrier (f) of a serving cell (c); and
calculate transmit power for each of the first set of PUSCH layers associated with the first indicated UL TCI state and the second set of PUSCH layers associated with the second indicated UL TCI state according to transmission parameters corresponding to each of the first set of PUSCH layers and the second set of PUSCH layers, respectively.

17. The processor of claim 16, wherein, in determining a transmission parameter Δ_{TF,b,f,c,t}(i) for each of the first indicated UL TCI state and the second indicated UL TCI state, for the SDM PUSCH transmission with UL-SCH data, the at least one controller is configured to cause the processor to calculate
$${BPRE}_{t} = {\sum }_{r = 0}^{{C}_{t} - 1} {K}_{r} / {N}_{RE , t}$$
as follows:
if only one codeword is scheduled, C is a number of transmitted code blocks of the one codeword, Kᵣ is a size for code block r, and N_{RE,t} is a number of resource elements for the scheduled SDM PUSCH transmission corresponding to an t^{th} indicated UL TCI state, and when N_{RE,t} is calculated, resource elements (REs) corresponding to all phase-tracking reference signal (RS) samples and all demodulation reference signal (DMRS) ports for the PUSCH layers associated with both the first indicated UL TCI state and the second indicated UL TCI state are excluded, or only REs corresponding to the phase-tracking RS samples and the DMRS ports for the PUSCH layers associated with the t^{th} indicated UL TCI state are excluded; and
if two codewords are scheduled, Cₜ is a number of transmitted code blocks for the codeword corresponding to the t^{th} indicated UL TCI state, Kᵣ is a size for code block r, and N_{RE,t} is a number of resource elements for the scheduled SDM PUSCH transmission corresponding to the t^{th} indicated UL TCI state, and when N_{RE,t} is calculated, only the phase tracking-RS (PT-RS) samples and the DMRS ports for the PUSCH layers associated with the t^{th} indicated UL TCI state are excluded.

18. The processor of claim 16, wherein, when power sharing among different panels for simultaneous UL transmission is supported, and additional maximum output power P_{CMAX,f,c} across both panels is configured, if P_{PUSCH,b,f,c,1}(i, j, q_{d}, l)+P_{PUSCH,b,f,c,2}(i, j, q_{d}, l)>P_{CMAX,f,c}(i), the at least one controller is further configured to cause the processor to perform power allocation for each of the first indicated UL TCI state and the second indicated UL TCI state by P′_{PUSCH,b,f,c,1}(i, j, q_{d}, l)=α×P_{CMAX,f,c}(i) and P′_{PUSCH,b,f,c,2}(i, j, q_{d}, l)=(1−α)×P_{CMAX,f,c}(i), where P_{PUSCH,b,f,c,1}(i, j, q_{d}, l) is the calculated transmit power for the first indicated UL TCI state, P_{PUSCH,b,f,c,2}(i, j, q_{d}, l) is the calculated transmit power for the second indicated UL TCI state, and α is a power allocation factor.

19. The processor of claim 18, wherein the at least one controller is configured to cause the processor to: determine the transmit power for the first indicated UL TCI state by \tilde{P}_{PUSCH,b,f,c,1}(i, j, q_{d}, l)=min{P_{CMAX,f,c,1}(i), P′_{PUSCH,b,f,c,1}(i, j, q_{d}, l)}, and determine the transmit power for the second indicated UL TCI state by \tilde{P}_{PUSCH,b,f,c,2}(i, j, q_{d}, l)=min{P_{CMAX,f,c,2}(i), P′_{PUSCH,b,f,c,2}(i, j, q_{d}, l)}.

20. The processor of claim 16, wherein the transmit power for each of the first indicated UL TCI state and the second indicated UL TCI state is applied by a scaling factor determined by the ratio of a number of antenna ports with non-zero PUSCH transmission power corresponding to the indicated UL TCI state over the maximum number of sounding reference signal (SRS) ports supported by the indicated UL TCI state.
